(19) United States
(12) Patent Application Publication
(10) Pub. No.: US 2025/0125365 A1
(43) Pub. Date: Apr. 17, 2025

(54) BINDER FOR SOLID ELECTROLYTE FILM FORMATION

(71) Applicants: KOREA KUMHO PETROCHEMICAL CO., LTD., Seoul (KR); SAMSUNG SDI CO., LTD., Yongin-si (KR)

(72) Inventors: Bo Na CHOI, Seoul (KR); June PARK, Seoul (KR); Won Yeong RYU, Seoul (KR); Seung Sik HWANG, Suwon-si (KR); Mok Won KIM, Suwon-si (KR); Yong Gun LEE, Suwon-si (KR)

(73) Assignees: KOREA KUMHO PETROCHEMICAL CO., LTD., Seoul (KR); SAMSUNG SDI CO., LTD., Yongin-si (KR)

(21) Appl. No.: 18/917,731

(22) Filed: Oct. 16, 2024

(30) Foreign Application Priority Data
Oct. 16, 2023 (KR) 10-2023-0137478

(51) Int. Cl. H01M 4/62; H01M 10/052; H01M 10/0562

(52) U.S. Cl. CPC H01M 4/622; H01M 10/052; H01M 10/0562

(57) ABSTRACT

Disclosed is a binder for forming a solid electrolyte film, comprising a first copolymer that includes structural units derived from a non-polar aromatic vinyl-based first monomer, an aliphatic conjugated diene-based second monomer, and a conjugated polyene-based third monomer; and a second copolymer including a structural unit derived from at least one of a polar monomer and a non-polar monomer, a film-type structure for a secondary battery including the same, and a secondary battery including the film-type structure.

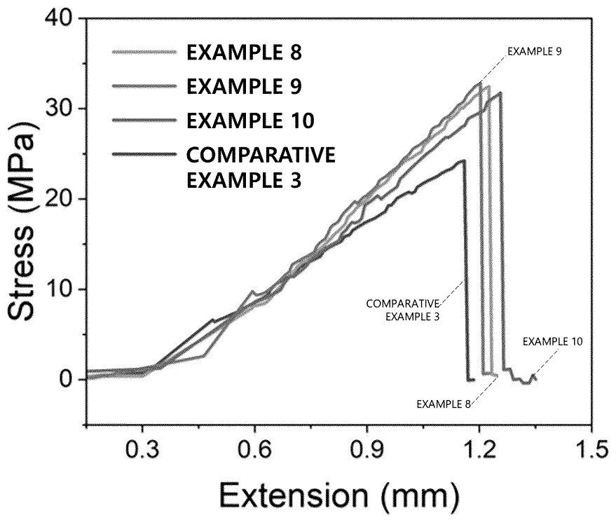

### CROSS-REFERENCE TO RELATED APPLICATION

This application claims priority to and the benefit of Korean Patent Application No. 10-2023-0137478, filed on Oct. 16, 2023, the disclosure of which is incorporated herein by reference in its entirety.

### BACKGROUND

### 1. Field of the Invention

The present invention relates to a binder for forming a solid electrolyte film.

### 2. Discussion of Related Art

Secondary batteries are batteries that can be repeatedly charged and discharged to convert chemical energy into electrical energy. With the development of portable electronic devices centered on smartphones and electric vehicles, the industrial demand for batteries with high energy density and high stability is increasing, and accordingly, research and development on secondary batteries is being actively conducted recently.

In the most widely used lithium-ion batteries, a liquid electrolyte that contain a flammable organic solvent is used. These lithium-ion batteries have a safety issue in which a fire or explosion occurs due to the liquid electrolyte when temperature is abnormally increased due to internal or external factors.

All-solid-state batteries, which use a solid electrolyte, have a lower risk of fire or explosion because they do not contain a flammable organic solvent as found in liquid electrolytes. Since the all-solid-state battery using a solid electrolyte has high stability, lithium with high energy density may be used in a negative electrode.

In the all-solid-state battery in which ions move via a solid electrolyte which is a solid-phase material, contact between solid electrolytes is important. However, when the volume of the components constituting the all-solid-state battery changes due to repeated charging and discharging, the performance of the battery may deteriorate.

In order to suppress the decrease in performance, the use of a binder that allows solid electrolyte particles to be bonded to each other has been proposed. However, a binder used in the positive electrode and negative electrode of conventional secondary batteries is dissolved only in a polar solvent and causes side reactions with a solid electrolyte in the polar solvent. Meanwhile, since a binder having no polar functional group has low binding strength to a solid electrolyte, when a solid electrolyte film is formed using this binder, film formation is insufficient.

Therefore, there is a need for the development of a binder which has excellent binding strength to a solid electrolyte and elasticity and can be dissolved and dispersed in a non-polar solvent.

### SUMMARY OF THE INVENTION

The description in the present specification was designed in consideration of the above-described problems of the related art, and the present invention is directed to providing a copolymer binder, which exhibits excellent performance such as binding strength, mechanical properties, and the like while being dissolved in a non-polar solvent that causes no side reaction with a solid electrolyte.

According to one aspect, there is provided a mixed copolymer binder, which includes a first copolymer including structural units derived from a non-polar aromatic vinyl-based first monomer, an aliphatic conjugated diene-based second monomer, and a conjugated polyene-based third monomer; and a second copolymer including a structural unit derived from at least one of a polar monomer and a non-polar monomer.

In an embodiment, the structural unit derived from the first monomer may be included in an amount of 15 to 45 parts by weight based on 100 parts by weight of the first copolymer.

In an embodiment, the structural unit derived from the third monomer may have at least one double bond.

In an embodiment, the third monomer may have 10 or more carbon atoms.

In an embodiment, the first copolymer may have a block structure including the structural unit derived from the second monomer or the third monomer at at least one end thereof.

In an embodiment, in the first copolymer, a block structure including the structural unit derived from the third monomer may be bonded to at least one end of a random structure including the structural units derived from the first monomer and the second monomer.

In an embodiment, in the first copolymer, a block structure including the structural unit derived from the second monomer may be bonded to at least one end of a random structure including the structural units derived from the first monomer and the third monomer.

In an embodiment, the first copolymer may include a first block including the structural unit derived from the first monomer, a second block including the structural unit derived from the second monomer, and a third block including the structural unit derived from the third monomer.

In an embodiment, in the first copolymer, the first block may be bonded to one end of the second block and the third block may be bonded to the other end of the second block.

In an embodiment, in the first copolymer, the structural units derived from the first monomer, the second monomer, and the third monomer may form a random structure.

In an embodiment, the first copolymer may include a branched copolymer in an amount of 5 to 75 wt % based on 100 wt % of the first copolymer.

In an embodiment, the sum of the structural units derived from the second monomer and the third monomer may be included in an amount of 60 wt % or more based on 100 wt % of the structural units of the first copolymer.

In an embodiment, the first copolymer may have a weight average molecular weight of 100,000 to 1,000,000 g/mol.

In an embodiment, the structural unit derived from the polar monomer in the second copolymer may include a structural unit derived from at least one of a nitrile-based monomer and a (meth)acrylate-based monomer.

In an embodiment, a weight ratio of the first copolymer and the second copolymer may be 1:0.5 to 5.

According to another aspect, there is provided a film-type structure for a secondary battery, which includes the above-described mixed copolymer binder; and at least one selected from the group consisting of a solid electrolyte, a positive electrode active material, and a negative electrode active material.

According to still another aspect, there is provided a secondary battery which includes the above-described film-type structure.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

The FIGURE shows a tensile testing result for the solid electrolyte films manufactured according to examples of the present specification.

### DETAILED DESCRIPTION OF EXEMPLARY EMBODIMENTS

Hereinafter, an aspect of the present specification will be described. However, the description in the present specification may be implemented in various different forms, and therefore is not limited to the embodiments described herein.

Throughout the present specification, when a part is said to be “connected” to another part, this includes not only the case where it is “directly connected,” but also the case where it is “indirectly connected” with another member interposed therebetween. When a part is said to “include” a certain component, this means that it may further include other components rather than excluding other components, unless specifically stated to the contrary.

When a range of numerical values is described herein, unless the specific range is stated, the value has the precision of significant figures given in accordance with the standard rules in chemistry for significant figures. For example, the number 10 ranges from 5.0 to 14.9, and the number 10.0 ranges from 9.50 to 10.49.

In the present specification, a “binder” is also called a binding agent and allows particulate materials used to manufacture a secondary battery, such as solid electrolyte, positive electrode active material, and negative electrode active material particles, to be bonded to each other.

In the present specification, a “conjugated diene” refers to a hydrocarbon-based compound having a structure in which two carbon-carbon double bonds are connected by a carbon-carbon single bond, and a “conjugated polyene” refers to a hydrocarbon-based compound including at least three double bonds while having a structure in which two carbon-carbon double bonds are connected by a carbon-carbon single bond.

In the present specification, an “aromatic” compound refers to a hydrocarbon-based compound including a ring structure having a conjugated pi electron system, and an “aliphatic” compound refers to a hydrocarbon-based compound not including the above-described aromatic ring.

In the present specification, “(meth)acryl” refers to “acryl” and/or methacryl,” and similar expressions thereto are also used in the same way.

In the present specification, a (co)polymer “including a structural unit derived from a monomer” refers to a polymer obtained using the monomer and includes a repeating structure derived from the monomer. As a method of measuring the content (wt %) of the structural unit, nuclear magnetic resonance (NMR) such as ¹H-NMR is used.

In the present specification, a “linear” type refers to a form in which carbon atoms constituting a compound are sequentially arranged, and a “branched” type refers to a form in which at least one carbon atom constituting a compound is bonded to three or more carbon atoms.

In the present specification, a “block” structure refers to a structure in which one structural unit is dominant in a certain region of a polymer chain, an “alternating” structure refers to a structure in which two or more structural units are alternately bonded in a certain region of a polymer chain, and a “random” structure refers to a structure in which two or more structural units are randomly bonded in a certain region of a polymer chain. For example, “ . . . -A-A-A-A- . . . ” may represent a block structure, “ . . . -A-B-A-B- . . . ” may represent an alternating structure, and “ . . . -A-B-B-A-B-A- . . . ” may represent a random structure. Also, in the present specification, when a polymer has structural units A and B, a block structure may be expressed as AB or A-B, and a random structure may be expressed as A/B. These polymer structures may be confirmed by various conventional methods such as Fourier-transform infrared spectroscopy (FT-IR), nuclear magnetic resonance (NMR) spectroscopy, differential scanning calorimetry (DSC), a Koldhof method, and the like. For example, a block structure may be confirmed by a Koldhof method in which observation is made by transmission electron microscopy (TEM) after a specific structural unit in a copolymer is stained with osmic acid.

### Mixed Copolymer Binder

A mixed copolymer binder according to one aspect includes a first copolymer including structural units derived from a non-polar aromatic vinyl-based first monomer, an aliphatic conjugated diene-based second monomer, and a conjugated polyene-based third monomer; and a second copolymer including a structural unit derived from at least one of a polar monomer and a non-polar monomer.

A solid electrolyte is a solid-phase material that replaces a conventional liquid electrolyte and enables ionic conduction. Unlike a conventional liquid electrolyte, when solid electrolyte particles are closely connected to each other, ions may rapidly move.

The mixed copolymer binder may be used to manufacture a thin film including a solid electrolyte, that is, a solid electrolyte film. Therefore, the mixed copolymer binder needs to cause no decrease in ionic conductivity due to having excellent binding strength to a solid electrolyte, have excellent flexibility, and be dissolved well in a non-polar solvent that does not react with a solid electrolyte. Also, the mixed copolymer binder needs to be easily detached from a release film used in manufacture of thin films.

In general, it is known that there is a trade-off relationship between chemical stability such as solubility, compatibility, and dispersibility and mechanical properties such as processability and adhesiveness in binders. Particularly, a non-polar binder that dissolves well in a non-polar solvent exhibits poor adhesive strength, and a polar binder that does not dissolve well in a non-polar solvent exhibits excellent adhesive strength. Also, a binder manufactured from a monomer including a polar functional group has a problem of limiting an ion conduction path because it easily covers the surface of a solid electrolyte.

However, the mixed binder manufactured by mixing the first copolymer prepared by copolymerizing a non-polar aromatic vinyl-based monomer, an aliphatic conjugated diene-based monomer, and a conjugated polyene-based monomer and the second copolymer may have excellent binding strength to a solid electrolyte and excellent solubility and dispersibility in a non-polar solvent by improving the above trade-off relationship. Therefore, when the mixed binder is used, the ionic conductivity of a solid electrolyte film can be improved, and the interfacial characteristics between electrode plates can be improved.

In addition, when the first copolymer is mixed with the second copolymer including the structural unit derived from the polar monomer, the resulting mixture may be used as a binder that exhibits excellent binding strength while being dissolved in a non-polar solvent.

The type of first monomer is not limited as long as it is a non-polar aromatic compound. The non-polar aromatic compound may be, for example, styrene, α-methylstyrene vinyltoluene, t-butylstyrene, 1,3-dimethylstyrene, 2,4-dimethylstyrene, ethylstyrene, or the like, but the present invention is not limited thereto.

The structural unit derived from the first monomer may impart relatively high rigidity to the first copolymer due to steric hindrance. For example, when the content of the structural unit derived from the first monomer increases, the mechanical properties of the first copolymer, such as hardness, elasticity, tensile strength, and the like, may be improved. Also, the structural unit derived from the first monomer may impart adhesive strength by increasing the cohesive strength of the first copolymer. Also, when the content of the structural unit derived from the first monomer increases, the glass transition temperature (T_{g}) of the first copolymer may increase. However, when the proportion of the structural unit derived from the first monomer excessively increases, the flexibility of a main chain decreases, and thus mechanical properties or adhesive strength may be degraded, or viscosity may be increased. As a result, usability may be degraded.

In an example, the content of the structural unit derived from the first monomer may be, based on 100 parts by weight of the first copolymer, 15 to 45 parts by weight, for example, 15 parts by weight, 17.5 parts by weight, 20 parts by weight, 22.5 parts by weight, 25 parts by weight, 27.5 parts by weight, 30 parts by weight, 32.5 parts by weight, 35 parts by weight, 37.5 parts by weight, 40 parts by weight, 42.5 parts by weight, or 45 parts by weight or in a range between two of these values, but the present invention is not limited thereto.

The type of second monomer is not limited as long as it is an aliphatic conjugated diene-based compound. The aliphatic conjugated diene-based compound may be, for example, 1,3-butadiene, isoprene, 2,3-dimethyl-1,3-butadiene, 2,3-dimethylbutadiene, 2-chloro-1,3-butadiene, 1,3-pentadiene, 2-methyl-1,3-pentadiene, 3-methyl-1,3-pentadiene, 4-methyl-1,3-pentadiene, 1,3-hexadiene, 2-ethyl-1,3-butadiene, 2,4-hexadiene, cyclo-1,3-hexadiene, or the like, but the present invention is not limited thereto.

The structural unit derived from the second monomer may impart relatively high flexibility to the first copolymer. For example, when the content of the structural unit derived from the second monomer increases, the viscoelasticity of the first copolymer may be reinforced. When the viscoelasticity of the first copolymer is reinforced, the adhesive strength of the binder may increase.

In the first copolymer, the structural unit derived from the second monomer may have various forms. For example, 1,3-butadiene, which is a typical example of the aliphatic conjugated diene-based compound, may form a cis-1,4 structure, a trans-1,4 structure, and a vinyl-1,2 structure in the copolymer chain. When the proportion of the cis structural unit in the first copolymer increases, crystallinity may increase, and a glass transition temperature (T_{g}) may be lowered. Also, when the proportion of the trans structural unit increases, crystallinity may decrease. Meanwhile, when the proportion of the vinyl structural unit increases, the glass transition temperature (T_{g}) of the first copolymer may increase. In this way, the properties of the first copolymer may be adjusted according to the type and proportion of the structural unit derived from the second monomer.

The type of third monomer is not limited as long as it is a conjugated polyene-based compound. The conjugated polyene-based compound may be, for example, myrcene, zingiberene, ocimene, α-farnesene, β-farnesene, lycopene, phytoene, phytofluene, or the like, but the present invention is not limited thereto. Among these conjugated polyene-based compounds, there are many environmentally friendly compounds that are obtainable from natural sources.

In addition, since the conjugated polyene-based compound has many multiple bonds, the structural unit derived therefrom may have various forms. Also, since three or more binding sites are present in one monomer, a network structure may be formed. If necessary, the conjugated polyene-based compound may be used to adjust the softening point and glass transition temperature (T_{g}) of the first copolymer.

The structural unit derived from the third monomer may include a short branch in which at least one double bond is present. The structure of the first copolymer may vary depending on the density of the branch. For example, the first copolymer may have the properties of a linear polymer, a branched polymer, or a star-shaped polymer according to the structural unit derived from the third monomer.

In an example, the structural unit derived from the third monomer may include at least one double bond. When the structural unit derived from either the second or third monomer, it may impart elasticity to the copolymer. When the first copolymer using the structural unit derived from the third monomer is applied in a binder, chemical bonding may be made to reinforce adhesive strength or impart a specific functional group to the first copolymer.

Meanwhile, the third monomer may have 10 or more carbon atoms. When a conjugated polyene-based compound having 10 or more carbon atoms is used as the third monomer, the glass transition temperature (T_{g}) and mechanical properties of the first copolymer may be improved. Also, the structural unit derived from the third monomer becomes relatively longer, and thus the chain of the first copolymer may become flexible.

Meanwhile, among the conjugated polyene-based compounds having 10 or more carbon atoms, there is also a compound capable of significantly improving the adhesive strength of the first copolymer due to having many multiple bonds. When the compound with the above characteristics is used as the third monomer, the low-temperature characteristics of a binder may be excellent.

The number of carbon atoms in the conjugated polyene-based compound may be 10 or more, for example, 10, 11, 12, 13, 14, 15, 16, 17, 18, 19, or 20 or more, but the present invention is not limited thereto.

If necessary, multiple bonds in the first copolymer may be hydrogenated to control the adhesiveness of the binder. For example, the structural units derived from the second monomer and the third monomer may have multiple bonds, some of which may be hydrogenated to adjust the characteristics of the binder.

The characteristics of the first copolymer may be adjusted by controlling the structure of the polymer chain in addition to above-described method of controlling the types and contents of first, second, and third monomers. The first copolymer may have at least one of a block structure, an alternating structure, and a random structure according to the arrangement form of structural units.

When the first copolymer includes a block structure derived from the first monomer, the block structure may be present in the form of rigid glass at an usage temperature of a final product and thus form a kind of cluster through chain entanglement. The cluster may not be compatible with the structural unit derived from the second monomer or the third monomer, and may have deformation stability by forming a three-dimensional network structure through physical crosslinking. Meanwhile, the cluster may dissociate at a temperature above the glass transition temperature (T_{g}) of the block structure due to high flowability and thus easily penetrate bonding targets.

When the first copolymer includes a block structure derived from the second monomer or the third monomer, elasticity may be imparted to the first copolymer. As a result, the impact resistance of a final product may be improved, and adhesive strength may be maintained even when the volume of a bonding target changes.

In an example, the first copolymer may have a block structure including the structural unit derived from the second monomer or the third monomer at at least one end thereof. When the first copolymer has the block structure at one end thereof, a solid electrolyte film manufactured therefrom may have excellent toughness. Here, toughness refers to the sum total of energy applied to an object until the object is destroyed from the moment it is deformed, and as the object has higher strength and flexibility, toughness is higher. In other words, the higher the strain energy per unit volume considering both stress and strain, the better the toughness. Meanwhile, the binder may have high adhesive strength according to the characteristics of the block structure included at one end of the first copolymer.

In an example, in the first copolymer, a block structure including the structural unit derived from the third monomer may be bonded to at least one end of a random structure including the structural units derived from the first monomer and the second monomer.

In another example, in the first copolymer, a block structure including the structural unit derived from the second monomer may be bonded to at least one end of a random structure including the structural units derived from the first monomer and the third monomer.

When a block structure including the structural unit derived from the second monomer or the third monomer is bonded to at least one end of the above random structures, the chain structure of the first copolymer may have flexibility and stickiness, and low-temperature characteristics such as interfacial resistance at low temperature may be excellent.

In still another example, the first copolymer may include a first block including the structural unit derived from the first monomer, a second block including the structural unit derived from the second monomer, and a third block including the structural unit derived from the third monomer. Such a first copolymer may be one in which the second block and the third block are bonded to both ends of the first block, one in which the first block and the third block are bonded to both ends of the second block, or one in which the first block and the second block are bonded to both ends of the third block.

Depending on the characteristics of the structural unit constituting the intermediate block in the first copolymer, the binding strength, thermal stability, mechanical properties, or solubility of the binder may be adjusted.

When the first copolymer includes three or more blocks, it has a firm chain structure, and thus the mechanical properties of a final product may be excellent. For example, toughness, maximum stress, elongation at break, and the like may increase.

Meanwhile, in the first copolymer, the structural units derived from the first monomer, the second monomer, and the third monomer may form a random structure. When the structural units form a random structure in the first copolymer, chain flexibility may be maximized.

Meanwhile, as the content of a branched copolymer in the first copolymer is lower, that is, as the linearity of the first copolymer is higher, the binder may be rapidly bonded. On the other hand, when the content of a branched copolymer increases, excellent properties may be exhibited even with the use of a relatively small amount of binder.

In the first copolymer, at least a portion of the linear copolymer may be branched (coupled) to form a branched copolymer. In the first copolymer, the content of the branched copolymer may be, based on 100 wt % of the first copolymer, 5 to 75 wt %, for example, 5 wt %, 10 wt %, 15 wt %, 20 wt %, 25 wt %, 30 wt %, 35 wt %, 40 wt %, 45 wt %, 50 wt %, 55 wt %, 60 wt %, 65 wt %, 70 wt %, or 75 wt % or in a range between two of these values.

The content of the branched copolymer may be measured by various known method. For example, the proportion thereof may be confirmed by gel permeation chromatography (GPC) using a polystyrene standard sample. Among the peaks observed in the GPC measurement results, the molecular weight of the branched copolymer is present in a relatively higher region than that of the linear copolymer. Therefore, the proportion of the branched copolymer may be confirmed from the area percentage of the relatively high molecular weight region. Alternatively, it may be indirectly confirmed through the degree of branching obtained from the ratio of Mooney viscosity and solution viscosity.

The sum of the structural units derived from the second monomer and the third monomer may be, based on 100 wt % of the structural units of the first copolymer, 60 wt % or more, for example, 60 wt %, 62.5 wt %, 65 wt %, 67.5 wt %, 70 wt %, 72.5 wt %, 75 wt %, 77.5 wt %, 80 wt %, 82.5 wt %, 85 wt %, 87.5 wt %, or 90 wt % or in a range between two of these values. This content may be selected depending on conditions for using a binder and desired effects.

The first copolymer may have a weight average molecular weight of 100,000 to 1,000,000 g/mol, for example, 100,000 g/mol, 105,000 g/mol, 110,000 g/mol, 115,000 g/mol, 120,000 g/mol, 125,000 g/mol, 130,000 g/mol, 135,000 g/mol, 140,000 g/mol, 145,000 g/mol, 150,000 g/mol, 155,000 g/mol, 160,000 g/mol, 165,000 g/mol, 170,000 g/mol, 175,000 g/mol, 180,000 g/mol, 185,000 g/mol, 190,000 g/mol, 195,000 g/mol, 200,000 g/mol, 225,000 g/mol, 250,000 g/mol, 275,000 g/mol, 300,000 g/mol, 325,000 g/mol, 350,000 g/mol, 375,000 g/mol, 400,000 g/mol, 425,000 g/mol, 450,000 g/mol, 475,000 g/mol, 500,000 g/mol, 600,000 g/mol, 700,000 g/mol, 800,000 g/mol, 900,000 g/mol, or 1,000,000 g/mol or in a range between two of these values. The weight average molecular weight of the first copolymer may be determined by GPC measurement with respect to a polystyrene standard sample.

A first copolymer according to another aspect may include structural units derived from two of the first monomer, the second monomer, and the third monomer. This copolymer may include, for example, structural units derived from the first monomer and the second monomer, structural units derived from the first monomer and the third monomer, or structural units derived from the second monomer and the third monomer.

The structural units may have a random structure or may be a diblock copolymer having blocks consisting of the structural units or a triblock copolymer in which other structural unit blocks are bonded to both ends of one structural unit block.

As described above, the first copolymer may have a rigid chain structure like a triblock copolymer or a flexible chain structure like a copolymer including a random structure according to the purpose of use.

Meanwhile, the second copolymer may include a structural unit derived from at least one of a polar monomer and a non-polar monomer. For example, the second copolymer may include a structural unit derived from a polar monomer, a structural unit derived from a non-polar monomer, or structural units derived from both a polar monomer and a non-polar monomer.

In the case of a solid electrolyte film manufactured from a binder including the above-described first copolymer and the second copolymer, electrical properties such as ionic conductivity, toughness, flexural strength, and the like and mechanical properties may be excellent in a balanced manner.

In an example, the second copolymer may include a structural unit derived from a polar monomer, which is at least one of a nitrile-based monomer and a (meth)acrylate-based monomer, and a structural unit derived from a non-polar monomer. When the second copolymer includes the structural unit derived from the polar monomer and the structural unit derived from the non-polar monomer, it may be well dissolved in a non-polar solvent when mixed with the first copolymer. Although the mechanism is not clearly known, the structural unit derived from the nonpolar monomer may impart compatibility with the first copolymer and the non-polar solvent to the second copolymer.

Since the second copolymer including a nitrile-based monomer may have relatively high rigidity, when the second copolymer is used in combination with the first copolymer having flexibility, excellent effects may be exhibited. The nitrile-based monomer may be, for example, at least one selected from the group consisting of acrylonitrile, methacrylonitrile, fumaronitrile, α-chloronitrile, and α-cyanoethylacrylonitrile, but the present invention is not limited thereto.

Meanwhile, since the second copolymer including a (meth)acrylate-based monomer may have relatively high flexibility, when the second copolymer is used in combination with the first copolymer having rigidity, excellent effects may be exhibited. The (meth)acrylate-based monomer may be a (meth)acrylic acid monomer capable of forming a (meth)acrylate structure. For example, the (meth)acrylate-based monomer may be methacrylic acid, acrylic acid, itaconic acid, maleic acid, fumaric acid, maleic anhydride, citraconic anhydride, styrene sulfonic acid, monobutyl fumarate, monobutyl maleate, mono-2-hydroxypropyl maleate, or the like, but the present invention is not limited thereto.

In addition, the second copolymer may include one or more of the nitrile-based monomer and the (meth)acrylate-based monomer as a polar monomer.

The type of non-polar monomer is not limited as long as it is a non-polar compound that is copolymerizable with the nitrile-based monomer or the (meth)acrylate-based monomer. For example, the non-polar monomer may be one or more selected from 1,3-butadiene, isoprene, 2,3-dimethyl-1,3-butadiene, 2,3-dimethylbutadiene, 2-chloro-1,3-butadiene, 1,3-pentadiene, 2-methyl-1,3-pentadiene, 3-methyl-1,3-pentadiene, 4-methyl-1,3-pentadiene, 1,3-hexadiene, 2-ethyl-1,3-butadiene, 2,4-hexadiene, cyclo-1,3-hexadiene, styrene, α-methylstyrenevinyltoluene, t-butylstyrene, 1,3-dimethylstyrene, 2,4-dimethylstyrene, ethylstyrene, and the like, but the present invention is not limited thereto.

If necessary, multiple bonds in the structural unit of the second copolymer may be hydrogenated to improve flexibility and adhesive strength.

When a second copolymer having a rigid chain is used, relatively high ionic conductivity may be achieved. On the other hand, when a second copolymer having a flexible chain is used, mechanical properties such as toughness may be improved.

Meanwhile, a weight ratio of the first copolymer and the second copolymer may be 1:0.5 to 5. For example, the mixed copolymer binder may include the second copolymer in an amount of 0.5 parts by weight, 1 part by weight, 1.5 parts by weight, 2 parts by weight, 2.5 parts by weight, 3 parts by weight, 3.5 parts by weight, 4 parts by weight, 4.5 parts by weight, or 5 parts by weight or in a range between two of these values based on 1 part by weight of the first copolymer. The above ratio may be adjusted according to the properties of the first copolymer and the second copolymer and the desired characteristics of the binder.

### Method of Manufacturing Mixed Copolymer Binder

A method of manufacturing a mixed copolymer binder according to another aspect includes preparing a first copolymer by polymerizing a non-polar aromatic vinyl-based first monomer, an aliphatic conjugated diene-based second monomer, and a conjugated polyene-based third monomer in the presence of a catalyst; and mixing the first copolymer with a second copolymer.

Here, the descriptions of the characteristics of the first monomer, second monomer, third monomer, first copolymer, and second copolymer are as described above.

In the manufacturing method, an anionic polymerization initiator may be used as the catalyst. As the anionic polymerization initiator, for example, an organolithium compound such as n-butyllithium or the like may be used, but the present invention is not limited thereto.

Meanwhile, a randomizing agent may be further used in the polymerization to form a random structure. The randomizing agent may serve to activate the anionic polymerization initiator, adjust a polymerization rate of each monomer, and adjust a ratio of structural units. As the randomizing agent, any randomizing agent typically used in anionic polymerization may be used, and for example, ditetrahydrofurylpropane or the like may be used, but the present invention is not limited thereto.

In addition, a coupling agent may be further used in the polymerization to increase the degree of branching of the first copolymer. Examples of the coupling agent include a carbonate-based compound, a chlorosilane-based compound, an ester-based compound, divinylbenzene, and the like, but the present invention is not limited thereto.

The structure of the first copolymer may vary depending on the difference in reactivity of monomers. For example, when several types of monomer are polymerized at the same time, a structural unit derived from a monomer having a relatively low reaction rate may form a block structure at the end of the first copolymer. Meanwhile, the reaction order of monomers may vary depending on the desired structural characteristics of the first copolymer.

For example, when the first monomer and the second monomer are first polymerized and the third monomer is added and polymerized, a block structure including the structural unit derived from the third monomer may be formed at one end of the first copolymer. Also, when the first monomer and the third monomer are first polymerized and the second monomer is added and polymerized, a block structure including the structural unit derived from the second monomer may be formed at one end of the first copolymer.

In another example, when one of the first monomer, second monomer, and third monomer is first polymerized and other monomers are added and polymerized, a block structure may be easily formed.

### Film-Type Structure for Secondary Battery

A film-type structure for a secondary battery according to still another aspect includes the above-described mixed copolymer binder; and at least one selected from the group consisting of a solid electrolyte, a positive electrode active material, and a negative electrode active material. Such a film-type structure may be a solid electrolyte layer, a positive electrode, a negative electrode, or the like.

In this case, the mixed copolymer binder may be included in an amount of 0.5 to 10 wt % based on solid content, for example, 0.5 wt %, 1 wt %, 1.5 wt %, 2 wt %, 2.5 wt %, 3 wt %, 3.5 wt %, 4 wt %, 4.5 wt %, 5 wt %, 5.5 wt %, 6 wt %, 6.5 wt %, 7 wt %, 7.5 wt %, 8 wt %, 8.5 wt %, 9 wt %, 9.5 wt %, or 10 wt % or in a range between two of these values.

When the content of the mixed copolymer binder is excessively low, binding strength may be insufficient, and on the other hand, when the content thereof is excessively high, the performance of a secondary battery including the film-type structure for a secondary battery may be degraded, or slurry application may be difficult.

Meanwhile, the film-type structure for a secondary battery may further include a conductive material, an auxiliary binder, and the like as needed.

The conductive material is used to impart conductivity so that electron movement occurs along with the movement of ions, and the type thereof is not limited as long as it has electronic conductivity and does not cause unnecessary chemical reactions. For example, the conductive material may be graphite, carbon black, acetylene black, Ketjen black, furnace black, lamp black, thermal black, carbon fiber, carbon nanotubes, graphene, copper, aluminum, nickel, gold, silver, conductive polymers, or the like.

For example, the film-type structure for a secondary battery may be a solid electrolyte film in which solid electrolyte particles are bonded to each other by the above-described mixed copolymer binder. The solid electrolyte film may separate a positive electrode and a negative electrode and provide an ion movement path.

The solid electrolyte film may have high ionic conductivity and excellent mechanical properties. For example, the solid electrolyte film may have an ionic conductivity at 25° C. of 0.4 mS/cm or more and a toughness of 0.3 MPa or more, but the present invention is not limited thereto.

Meanwhile, the solid electrolyte film may have free-standing characteristics that allows it to be used without a separate support. The free-standing solid electrolyte film including the above-described binder may have a flexural strength of 27.5 Mpa or more, but the present invention is not limited thereto.

Such a solid electrolyte film may be manufactured by mixing a solid electrolyte and the mixed copolymer binder in a non-polar solvent that does not react with the solid electrolyte to prepare a slurry, applying and drying the slurry on a release film to form a film-type structure, and then detaching the release film.

Examples of the solid electrolyte include a sulfide-based solid electrolyte, an oxide-based solid electrolyte, a phosphide-based solid electrolyte, and the like, but the present invention is not limited thereto.

Meanwhile, the film-type structure for a secondary battery may be an electrode, that is, a positive electrode or a negative electrode. Particularly, an electrode for an all-solid-state battery may further include a solid electrolyte in addition to an active material. In such an electrode, the mixed copolymer binder may allow solid electrolyte and active material particles to be bonded. Alternatively, active material particles whose surface has been coated with a solid electrolyte may be bonded by the mixed copolymer binder.

The electrode may be manufactured by mixing a solid electrolyte, a positive electrode active material or a negative electrode active material, and the mixed copolymer binder in a non-polar solvent that does not react with the solid electrolyte to prepare a slurry and applying and drying the slurry on a current collector.

Alternatively, the electrode may be manufactured by mixing a solid electrolyte, a positive electrode active material or a negative electrode active material, and the mixed copolymer binder in a non-polar solvent that does not react with the solid electrolyte to prepare a slurry, applying and drying the slurry on a release film to form a film-type structure, detaching the film-type structure from the release film, and then laminating the same on a current collector.

As the active material, a compound capable of reversible intercalation and deintercalation of lithium, sodium, magnesium, or the like, may be used.

The positive electrode active material may be, for example, a cobalt oxide-based compound (LCO), a nickel oxide-based compound (LNO), a manganese oxide-based compound (LMO), a nickel cobalt manganese oxide-based compound (NCM), a nickel cobalt aluminum oxide-based compound (NCA), an iron phosphate-based compound (LFP), or a doping and/or coating product thereof, but the present invention is not limited thereto.

As the current collector used in manufacture of the positive electrode, any current collector may be used without limitation as long as it has conductivity and does not cause unnecessary chemical reactions. For example, aluminum, nickel, titanium, sintering carbon, stainless steel, or the like may be used.

The negative electrode active material may be, for example, a graphite-based, silicon-based, tin-based, or vanadium-based compound, but the present invention is not limited thereto.

As the current collector used in manufacture of the negative electrode, any current collector may be used without limitation as long as it has conductivity and does not cause unnecessary chemical reactions. For example, copper, aluminum, nickel, titanium, silver, carbon, stainless steel, or the like may be used.

Meanwhile, the solid electrolyte and the positive electrode active material or negative electrode active material may be a lithium-based, sodium-based, or magnesium-based compound.

### Secondary Battery

A secondary battery according to yet another aspect includes the above-described film-type structure. The secondary battery is a kind of electrochemical device that is capable of storing and using energy through charging and discharging which is the conversion of electrical energy and chemical energy.

In general, the secondary battery includes a positive electrode, a negative electrode, a separator, and an electrolyte, but when the solid electrolyte film, which is one of the above-described film-type structures, is included, the separator may be omitted. In this case, the solid electrolyte film may be interposed between the positive electrode and the negative electrode and serve as a separator that prevents direct contact between the positive electrode and the negative electrode. Such a secondary battery is called an all-solid-state battery by not including a liquid-phase component.

In addition to the solid electrolyte film in the secondary battery, the positive electrode and/or the negative electrode may be one of the above-described film-type structures. For description of the positive electrode or negative electrode film-type structure, refer to the above-described descriptions.

Meanwhile, in the secondary battery including the solid electrolyte film, which is one of the above-described film-type structures, lithium metal may be used as the negative electrode. The lithium metal negative electrode is known to have a specific capacity almost 10 times that of a commonly used graphite negative electrode active material.

Meanwhile, even when the secondary battery includes a solid electrolyte film, it may further include a liquid electrolyte. A composite secondary battery including both a solid electrolyte film and a liquid electrolyte may exhibit high ionic conductivity and excellent stability.

The secondary battery may further include a container that accommodates the above-described components and a sealing member that seals the container. As the container, a cylindrical can, a prismatic can, a coin-type can, a pouch, or the like may be used, and the type thereof is not limited.

As described above, the secondary battery including the mixed copolymer binder according to the present specification has high ionic conductivity and high mechanical strength by having excellent binding strength of solid electrolyte particles. Therefore, the secondary battery may be applied in various fields such as portable electronic devices including mobile phones and portable computers, electric vehicles (EVs), energy storage systems (ESSs), and the like.

For example, a battery cell, which is the minimum unit including all of the positive electrode, negative electrode, and solid electrolyte film, may be used in portable electronic devices. In addition, a battery module including a plurality of such battery cells and/or a battery pack using the battery module may be used as a power source for EVs, ESSs, and the like.

Hereinafter, examples of the present specification will be described in further detail. However, the following experimental results are obtained from only a few selected examples of the invention, and the scope and contents of the present specification should not be interpreted as being reduced or limited by the few selected examples. The effects of each of the various embodiments of the present specification, which are not explicitly set forth below, will be described in detail in relevant sections.

### Preparation Example 1

2,200 g of cyclohexane, 200 ppm of a randomizing agent, 80 g of styrene, and 160 g of butadiene were input into a 5 L nitrogen-substituted reactor and mixed. The temperature of the reactor was adjusted to 60° C., and then n-butyllithium was added to initiate a reaction. When the temperature of the reactor reached its peak due to an exothermic reaction, the reaction was continued for another 10 minutes to allow all the monomers to react, and then 160 g of β-farnesene was added and polymerized for 20 minutes. Afterward, based on the total weight of the monomers, 1.1 molar equivalents of triethoxysilylpropyl diethylamine was added to terminate the polymerization. The product was reprecipitated with toluene and ethanol and dried in a vacuum oven set at 40° C. for at least 4 hours to remove the residual solvent. As a result, a copolymer (S/B-F 244) in which a farnesene block was formed at one end of a styrene-butadiene random structure was prepared. In this case, the copolymer had a styrene content of 20 wt %, a butadiene content of 40 wt %, a farnesene content of 40 wt %, a weight average molecular weight of 162,000 g/mol, and a glass transition temperature (T_{g}) of −27.5° C. Here, 11% of the copolymer was coupled to form a branched structure having a weight average molecular weight of 343,000 g/mol.

### Preparation Example 2

Random anionic polymerization was performed using a butyllithium initiator in cyclohexane to synthesize a styrene-farnesene random copolymer, and a butadiene monomer was polymerized at the end of the random copolymer to prepare a copolymer (S/F-B 442) in which a butadiene block was formed at one end of the styrene-farnesene random copolymer. In this case, the copolymer had a styrene content of 40 wt %, a butadiene content of 40 wt %, a farnesene content of 20 wt %, and a weight average molecular weight of 100,000 g/mol.

### Preparation Example 3

Anionic polymerization was performed using a butyllithium initiator in cyclohexane to prepare a styrene-butadiene-farnesene block copolymer (S-B-F 262) having a styrene content of 20 wt %, a butadiene content of 60 wt %, a farnesene content of 20 wt %, and a molecular weight of 200,000 g/mol.

### Preparation Example 4

Random anionic polymerization was performed using a butyllithium initiator in cyclohexane to synthesize a styrene-butadiene random copolymer, and a farnesene monomer was polymerized at the end of the random copolymer to prepare a copolymer (S/B-F 262) in which a farnesene block was formed at one end of the styrene-butadiene random copolymer. In this case, the copolymer had a styrene content of 20 wt %, a butadiene content of 60 wt %, a farnesene content of 20 wt %, and a molecular weight of 97,000 g/mol. Here, 71% of the copolymer was coupled to exhibit a weight average molecular weight of 368,000 g/mol.

### Preparation Example 5

Random anionic polymerization was performed using a butyllithium initiator in cyclohexane to prepare a styrene-butadiene-farnesene random copolymer (S/B/F 262) having a styrene content of 20 wt %, a butadiene content of 60 wt %, a farnesene content of 20 wt %, a molecular weight of 163,000 g/mol, and a T_{g} of −40° C. Here, 30% of the copolymer was coupled to form a branched structure having a weight average molecular weight of 526,000 g/mol.

### Preparation Example 6

Random anionic polymerization was performed using a butyllithium initiator in cyclohexane to prepare a styrene-butadiene-farnesene random copolymer (S/B/F 244) having a styrene content of 20 wt %, a butadiene content of 40 wt %, a farnesene content of 40 wt %, a molecular weight of 164,000 g/mol, and a T_{g} of −41° C. Here, 27% of the copolymer was coupled to form a branched structure having a weight average molecular weight of 469,000 g/mol.

### Preparation Example 7

Random anionic polymerization was performed using a butyllithium initiator in cyclohexane to prepare a styrene-butadiene-farnesene random copolymer (S/B/F 226) having a styrene content of 20 wt %, a butadiene content of 60 wt %, a farnesene content of 20 wt %, a molecular weight of 159,000 g/mol, and a T_{g} of −69° C. and −37° C. Here, 23% of the copolymer was coupled to form a branched structure having a weight average molecular weight of 446,000 g/mol.

### Other Binders

Conventional binders for a solid electrolyte, that is, hydrogenated nitrile butadiene rubber (H-NBR) having a degree of hydrogenation of 99% or more, a nitrile content of 17 wt %, and a weight average molecular weight of 300,000 g/mol, and an ethylene vinyl acetate (EVA) copolymer having structural units derived from styrene, acrylic acid, acrylate, and acrylonitrile monomers, were prepared.

### Example 1

The H-NBR and the copolymer prepared in Preparation Example 1 were mixed in a weight ratio of 2:1, and the resulting mixture was used as a binder.

A solid electrolyte (Li₆PS₅Cl), the mixed binder, and a dispersant were dissolved and dispersed in an octyl acetate solvent in a weight ratio of 98:1.5:0.5 based on solid content to prepare a slurry having a solid content of 56 wt %. The slurry was applied on a non-woven fabric substrate having a thickness of 10 μm and a porosity of 90%, and the solvent was evaporated to manufacture a solid electrolyte film having a thickness of 90 to 100 μm.

### Example 2

A solid electrolyte film was manufactured in the same manner as in Example 1, except that the copolymer prepared in Preparation Example 2 was used instead of the copolymer prepared in Preparation Example 1.

### Example 3

A solid electrolyte film was manufactured in the same manner as in Example 1, except that the copolymer prepared in Preparation Example 3 was used instead of the copolymer prepared in Preparation Example 1.

### Example 4

A solid electrolyte film was manufactured in the same manner as in Example 1, except that a binder obtained by mixing the EVA copolymer and the copolymer prepared in Preparation Example 1 in a weight ratio of 2:1 was used instead of the binder obtained by mixing the H-NBR and the copolymer prepared in Preparation Example 1 in a weight ratio of 2:1.

### Example 5

A solid electrolyte film was manufactured in the same manner as in Example 4, except that the copolymer prepared in Preparation Example 2 was used instead of the copolymer prepared in Preparation Example 1.

### Example 6

A solid electrolyte film was manufactured in the same manner as in Example 4, except that the copolymer prepared in Preparation Example 3 was used instead of the copolymer prepared in Preparation Example 1.

### Example 7

A solid electrolyte film was manufactured in the same manner as in Example 4, except that the copolymer prepared in Preparation Example 4 was used instead of the copolymer prepared in Preparation Example 1.

### Example 8

The EVA copolymer and the copolymer prepared in Preparation Example 5 were mixed in a weight ratio of 2:1, and the resulting mixture was used as a binder.

A solid electrolyte (Li₆PS₅Cl), the mixed binder, and a dispersant were dissolved and dispersed in an octyl acetate solvent in a weight ratio of 96.5:3.0:0.5 based on solid content to prepare a slurry having a solid content of 54 wt %. The slurry was applied on a release film, the solvent was evaporated, and then the release film was detached to manufacture a solid electrolyte film having a thickness of 200 μm.

### Example 9

A solid electrolyte film was manufactured in the same manner as in Example 8, except that the copolymer prepared in Preparation Example 6 was used instead of the copolymer prepared in Preparation Example 5.

### Example 10

A solid electrolyte film was manufactured in the same manner as in Example 8, except that the copolymer prepared in Preparation Example 7 was used instead of the copolymer prepared in Preparation Example 5.

### Example 11

The EVA copolymer and the copolymer prepared in Preparation Example 1 were mixed in a weight ratio of 2:1, and the resulting mixture was used as a binder.

A solid electrolyte (Li₆PS₅Cl), the mixed binder, and a dispersant were dissolved and dispersed in an octyl acetate solvent in a weight ratio of 96.5:3.0:0.5 based on solid content to prepare a slurry having a solid content of 54 wt %. The slurry was applied on a release film, the solvent was evaporated, and then the release film was detached to manufacture a solid electrolyte film having a thickness of 100 μm.

LiNi_{0.8}Co_{0.15}Al_{0.05}O₂(NCA) (D₅₀=14 μm) as a positive electrode active material, carbon nanofibers as a conductive material, polyvinylidene fluoride (PVDF) as a binder, and a solid electrolyte (Li₆PS₅Cl) were dissolved and dispersed in octyl acetate in a weight ratio of 84:0.2:1.0:14.8 based on solid content to prepare a slurry. The slurry was shaped in the form of a sheet to manufacture a positive electrode sheet. The manufactured positive electrode sheet was pressed on an aluminum foil current collector having a thickness of 18 μm, placed in an oil chamber, and subjected to warm isostatic pressing (WIP) with a pressure of 500 MPa at 90° C. for 1 hour to manufacture a positive electrode.

As a negative electrode current collector, a SUS foil having a thickness of 10 μm was prepared. As a negative electrode active material, a powder obtained by mixing carbon black (CB35) having a primary particle diameter of about 38 nm and silver (Ag) particles having an average particle diameter of about 60 nm in a weight ratio of 3:1 was prepared. 4 g of the powder was mixed with 6 g of an NMP solution containing 5 wt % of a PVDF binder, and NMP was added thereto little by little while stirring to prepare a negative electrode slurry. The negative electrode slurry was applied on an Ni foil using a blade coater and dried under 80° C. air conditions for 20 minutes. Afterward, vacuum drying was performed at 100° C. for 12 hours to manufacture a negative electrode.

The positive electrode, the solid electrolyte film, and the negative electrode were sequentially stacked, then pressed, and subjected to WIP with a pressure of 500 MPa at 90° C. for 1 hour to manufacture an all-solid-state battery having an area of 4 cm².

### Example 12

An all-solid-state battery was manufactured in the same manner as in Example 11, except that the copolymer prepared in Preparation Example 6 was used instead of the copolymer prepared in Preparation Example 1.

### Comparative Example 1

A solid electrolyte film was manufactured in the same manner as in Example 4, except that the H-NBR alone was used as a binder.

### Comparative Example 2

A solid electrolyte film was manufactured in the same manner as in Example 4, except that the EVA copolymer alone was used as a binder.

### Comparative Example 3

A solid electrolyte film was manufactured in the same manner as in Example 8, except that the EVA copolymer alone was used as a binder.

### Comparative Example 4

An all-solid-state battery was manufactured in the same manner as in Example 11, except that the EVA copolymer was used as a binder.

### Experimental Example 1

The properties of the solid electrolyte film samples manufactured in Examples 1 to 7 and Comparative Examples 1 and 2 were measured by the following methods, and results thereof are shown in Table 1.
Ionic conductivity: 10 solid electrolyte films were stacked and pressed with a pressure of 4 tons to prepare a sample for measuring ionic conductivity. Indium (In) electrodes having a thickness of 50 μm and a diameter of 13 mm were disposed at both surfaces of the sample under an argon atmosphere to manufacture a symmetric cell. The impedance of the solid electrolyte film was measured by a 2-probe method using an impedance analyzer at 25° C. In this case, the frequency range was set to 0.1 Hz to 1 MHz, and the amplitude voltage was set to 10 mV. After a resistance value was calculated from the arc of a Nyquist plot, ionic conductivity was calculated in consideration of the area and thickness of the sample.
Toughness: A rectangular tensile testing sample having a width of 12 mm and a length of 60 mm was prepared. While the sample was stretched at a rate of 5 mm/min using a universal testing machine (UTM), a stress-strain curve was obtained, and integrated to calculate a toughness value.

TABLE 1

| | | Ionic conductivity | Toughness |
|---|---|---|---|
| Classification | Type of binder | (mS/cm @25° C.) | (MPa) |
| Example 1 | H-NBR/(S/B-F 244) | 0.51 | 0.36 |
| Example 2 | H-NBR/(S/F-B 442) | 0.47 | 0.40 |
| Example 3 | H-NBR/(S-B-F 262) | 0.40 | 0.40 |
| Comparative | H-NBR | 0.24 | 0.29 |
| Example 1 | | | |
| Example 4 | PA/(S/B-F 244) | 0.62 | 0.33 |
| Example 5 | PA/(S/F-B 442) | 0.60 | 0.39 |
| Example 6 | PA/(S-B-F 262) | 0.62 | 0.32 |
| Example 7 | PA/(S/B-F 262) | 0.54 | 0.55 |
| Comparative | PA | 0.51 | 0.26 |
| Example 2 | | | |

Referring to Table 1, in the case of the mixed binders of the examples unlike the comparative examples using only a conventional polar binder, ionic conductivity and mechanical properties were excellent in a balanced manner. This seems to be because, when copolymers different properties are blended, the adhesiveness of the binder is adjusted, and thus binding strength to a solid electrolyte could be improved.

### Experimental Example 2

The properties of the manufactured solid electrolyte film samples were measured by the following methods, and results thereof are shown in Table 2 and the FIGURE.
Ionic conductivity: 5 solid electrolyte films were stacked and pressed with a pressure of 4 tons to prepare a sample for measuring ionic conductivity. Indium (In) electrodes having a thickness of 50 μm and a diameter of 13 mm were disposed at both surfaces of the sample under an argon atmosphere to manufacture a symmetric cell. The impedance of the solid electrolyte film was measured by a 2-probe method using an impedance analyzer at 25° C. In this case, the frequency range was set to 0.1 Hz to 1 MHz, and the amplitude voltage was set to 10 mV. After a resistance value was calculated from the arc of a Nyquist plot, ionic conductivity was calculated in consideration of the area and thickness of the sample.
Flexural strength: The solid electrolyte film was placed in an oil chamber and subjected to warm isostatic pressing (WIP) with a pressure of 500 MPa at 85° C. for 30 minutes to manufacture a free-standing solid electrolyte film. The sample was disposed between a first point and a second point having an interval of 14 mm using a 3-point flexural method. The center of the sample was designated as a third point. A preload of 0.05 N was applied to the third point using a probe having a tip diameter of 2 mm. Afterward, the load applied when the sample was broken while being pressurized at a constant rate of 0.5 mm/min in the thickness direction was measured. 6 samples were measured, and the average was used as a flexural strength value.
Toughness: A rectangular tensile testing sample having a width of 12 mm and a length of 60 mm was prepared. While the sample was stretched at a rate of 5 mm/min using a UTM, a stress-strain curve was obtained, and integrated to calculate a toughness value.

TABLE 2

| | | | Flexural | |
|---|---|---|---|---|
| | | Ionic conductivity | strength | Toughness |
| Classification | Type of binder | (mS/cm @25 ° C.) | (MPa) | (Nmm) |
| Example 8 | PA/(S/B/F 262) | 0.84 | 32.8 | 0.093 |
| Example 9 | PA/(S/B/F 244) | 0.85 | 32.8 | 0.089 |
| Example 10 | PA/(S/B/F 226) | 0.83 | 31.8 | 0.085 |
| Comparative | PA | 0.71 | 25.7 | 0.078 |
| Example 3 | | | | |

Referring to Table 2, the free-standing solid electrolyte films manufactured using the mixed binders of the examples exhibited excellent properties such as ionic conductivity, flexural strength, and toughness compared to a solid electrolyte film using only a conventional binder according to the comparative example.

### Experimental Example 3

The rate characteristics of the all-solid-state batteries manufactured in Examples 11 and 12 and Comparative Example 4 were evaluated, and results thereof are shown in the following Table 3.
Rate characteristic test: The all-solid-state battery was placed in a chamber set at 45° C. The battery was subjected to one cycle of charging and discharging at a constant current of 0.1 C, 0.33 C, and 1.0 C, and the discharge capacity according to the C-rate was measured.

TABLE 3

| | | | | | 1.0 C/ |
|---|---|---|---|---|---|
| | | 0.1 C | 0.33 C | 1.0 C | 0.1 C |
| | | discharge | discharge | discharge | discharge |
| | | capacity | capacity | capacity | capacity |
| Classification | Binder | (mAh/g) | (mAh/g) | (mAh/g) | ratio |
| Example 11 | PA/ | 200.7 | 187.9 | 172.8 | 86.1% |
| | (S/B-F 244) | | | | |
| Example 12 | PA/ | 209.2 | 196.6 | 181.9 | 86.9% |
| | (S/B/F 244) | | | | |
| Comparative | PA | 198.6 | 185.1 | 165.3 | 83.3% |
| Example 4 | | | | | |

Referring to Table 3, when the solid electrolyte film including the mixed binder was used as in the examples, the battery had low resistance, and thus battery characteristics could be improved compared to the comparative example.

According to one aspect, a mixed copolymer binder, which can be used to form a solid electrolyte film due to being dispersed well in a non-polar solvent, exhibits excellent binding strength, and is advantageous in terms of interfacial resistance, can be provided.

The effects of one aspect of the present specification are not limited to the above-described effects and should be understood as including all effects that can be inferred from the configurations described in the detailed description or claims of the present specification.

The foregoing description of the present specification is intended for illustration, and it will be understood by those skilled in the art to which the present invention pertains that the present invention can be easily modified in other specific forms without changing the technical spirit or essential features described in the present specification. Therefore, it should be understood that the embodiments described above are only exemplary in all aspects and not limiting. For example, each of the constituents described as being one combined entity may be implemented separately, and similarly, constituents described as being separate entities may be implemented in a combined form.

It should be understood that the scope of the present specification is defined by the following claims and that all changes or modifications derived from the meaning and scope of the claims and their equivalents are included in the scope of the present specification.

What is claimed is:

1. A mixed copolymer binder comprising:
a first copolymer including structural units derived from a non-polar aromatic vinyl-based first monomer, an aliphatic conjugated diene-based second monomer, and a conjugated polyene-based third monomer; and
a second copolymer including a structural unit derived from at least one of a polar monomer and a non-polar monomer.

2. The mixed copolymer binder of claim 1, wherein the structural unit derived from the first monomer is included in an amount of 15 to 45 parts by weight based on 100 parts by weight of the first copolymer.

3. The mixed copolymer binder of claim 1, wherein the structural unit derived from the third monomer has at least one double bond.

4. The mixed copolymer binder of claim 1, wherein the third monomer has 10 or more carbon atoms.

5. The mixed copolymer binder of claim 1, wherein the first copolymer has a block structure including the structural unit derived from the second monomer or the third monomer at at least one end thereof.

6. The mixed copolymer binder of claim 5, wherein in the first copolymer, a block structure including the structural unit derived from the third monomer is bonded to at least one end of a random structure including the structural units derived from the first monomer and the second monomer.

7. The mixed copolymer binder of claim 5, wherein in the first copolymer, a block structure including the structural unit derived from the second monomer is bonded to at least one end of a random structure including the structural units derived from the first monomer and the third monomer.

8. The mixed copolymer binder of claim 5, wherein the first copolymer includes a first block including the structural unit derived from the first monomer, a second block including the structural unit derived from the second monomer, and a third block including the structural unit derived from the third monomer.

9. The mixed copolymer binder of claim 8, wherein in the first copolymer, the first block is bonded to one end of the second block and the third block is bonded to the other end of the second block.

10. The mixed copolymer binder of claim 1, wherein in the first copolymer, the structural units derived from the first monomer, the second monomer, and the third monomer form a random structure.

11. The mixed copolymer binder of claim 1, wherein the first copolymer includes a branched copolymer in an amount of 5 to 75 wt % based on 100 wt % of the first copolymer.

12. The mixed copolymer binder of claim 1, wherein the sum of the structural units derived from the second monomer and the third monomer is included in an amount of 60 wt % or more based on 100 wt % of the structural units of the first copolymer.

13. The mixed copolymer binder of claim 1, wherein the first copolymer has a weight average molecular weight of 100,000 to 1,000,000 g/mol.

14. The mixed copolymer binder of claim 1, wherein the structural unit derived from the polar monomer in the second copolymer includes a structural unit derived from at least one of a nitrile-based monomer and a (meth)acrylate-based monomer.

15. The mixed copolymer binder of claim 1, wherein a weight ratio of the first copolymer and the second copolymer is 1:0.5 to 5.

16. A film-type structure for a secondary battery, comprising:
the mixed copolymer binder according to claim 1; and
at least one selected from the group consisting of a solid electrolyte, a positive electrode active material, and a negative electrode active material.

17. A secondary battery comprising the film-type structure according to claim 16.
